(19) United States
(12) Patent Application Publication
(10) Pub. No.: US 2001/0035351 A1
(43) Pub. Date: Nov. 1, 2001

(54) Cross channel device for serial sample injection

(76) Inventors: Peter C. Simpson, Palo Alto, CA (US); Ezra Van Gelder, Palo Alto, CA (US)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/803,724

(22) Filed: Mar. 9, 2001

Related U.S. Application Data
(60) Provisional application No. 60/188,587, filed on Mar. 10, 2000.

(51) Int. Cl. G01N 27/26

(52) U.S. Cl. 204/453; 204/450; 204/451; 204/600; 204/601; 204/604

(57) ABSTRACT

The present invention provides a microfluidic analytical device and accompanying methods for injecting a sample and separating the components therein comprising an injection channel and an intersecting separation channel, the two channels formed to be in continuous fluid communication with one another. The separation channel preferably includes a separation material for resolving the components in a sample. The methods include using a first force, preferably a pressure differential, and a second force, preferably an electric field, to move samples through the microchannels. The device and methods are specially adapted to accommodate multiple sample injection and separation. Thus, the device and methods allow for increased sample throughput and are simple and inexpensive to carry out compared to related devices and methods.

### RELATED APPLICATION

This application claims the benefit of provisional Application Ser. No. 60/188,587 filed Mar. 10, 2000, the fill disclosure of which is herein incorporated by reference.

### FIELD OF THE INVENTION

The present invention generally relates to methods and devices useful for the chromatographic and/or electrophoretic separation of materials. More specifically, the present invention relates to the field of sample injection and separation using devices which include a micro-channel network.

### BACKGROUND OF THE INVENTION

There is a need for reliable analytical devices capable of providing for the rapid injection, separation and detection of the components contained in microquantities of biological samples in order for the most recent advances in separation technology to be commercially viable and fully available for use in research and the diagnosis of disease. There is a particular need for devices and methods for analyzing genetic materials such as DNA, because variations in DNA can be associated with various genetic disorders.

Because the sample volumes typically available in biological research and medical diagnosis are frequently very small, considerable research has been directed towards developing microfluidic devices capable of separating and detecting minute quantities of biological material. Technology originally developed in the semiconductor electronics industry, such as photolithography and wet chemical etching, has been utilized in developing microfluidic systems for the separation of biological samples. The term “microfluidic” as typically used refers to a device created using the technologies just mentioned to fabricate channels and/or chambers in a substrate or wafer which may be as small as the micron or submicron scale. Early work in this field, particularly the fabrication of microfluidic devices in silicon and glass substrates, is described in Manz et al., Trends in Anal. Chem., 10:144-149, 1990, and Manz et al., Adv. in Chromatog., 33:166, 1993. These references are incorporated herein by reference in their entirety for all purposes.

The separation of sample components using microfluidic devices is typically achieved using various chromatographic or electrophoretic methods. Electrophoretic separation methods are based upon the different migration rates of the individual components of a test sample in a carrier medium when an electric field is applied. Individual components can be detected using a detector associated with the channel in which separation occurs. In DNA analysis, a gel-filled separation channel is often used.

In most existing microfluidic devices designed for sample analysis, samples are moved through the micro-channel network by application of a single force to the micro-channels. Most commonly, samples are transported through the microchannels by applying and varying multiple electric fields. Exclusive reliance on electric fields for sample movement in microfluidic devices presents several shortcomings. For example, such devices are relatively complex because an electrode or series of electrodes often must be run to each channel. In some instances, the devices are even more complex because they also include gates or valves for controlling movement through the various channels. Methods relying exclusively on electric fields for sample movement typically are relatively time consuming because of the care which must be taken in appropriately adjusting the magnitude of the electric field in order to achieve the desired movement through the channels. Such methods are further slowed by the fact that it is frequently necessary to flush the reservoirs and channel with buffer in between assays in order to protect against sample contamination. In addition, sample throughput may also be reduced in devices which utilize gates or valves to regulate solution flow. This is due to the fact that in such devices, sample loading and sample separation occur as two discrete steps and require controlled opening and closure of the appropriate gates and valves.

### SUMMARY OF THE INVENTION

The present invention provides systems and associated methods for rapidly injecting and efficiently separating microquantities of sample on a microfluidic device.

In preferred aspects, the present invention provides a microfabricated analytical device for at least partially separating the components of a sample. Such device preferably comprises: (a) a first channel having a sample reservoir at one end and a waste reservoir at an opposite end; (b) a second channel which intersects across the first channel, the second channel comprising an electrophoretic separation channel; and (c) a system adapted to move a sample from the sample reservoir across the first channel and into an intersection between the first and second channels. In a first embodiment, the system adapted to move a sample from the sample reservoir across the first channel comprises a system for generating a pressure differential across the first channel. In a second embodiment, the system adapted to move a sample from the sample reservoir across the first channel comprises an electrokinetic system.

In a preferred aspects, the present invention also provides a system adapted to perform multiple serial sample injection and separation. In preferred aspects, it is not necessary to change the separation material (used to achieve separation of components within the injected sample) between the separation of sequential samples.

In an optional preferred aspect, the present invention provides a system adapted to load multiple samples into the sample reservoir, either before or after the sample injection and separation process has begun.

The present invention significantly increases the throughput for analyzing samples as compared to current designs by allowing multiple serial injections onto the separation column. This feature of the invention is particularly advantageous for the analysis of various biological samples and has special utility in the process of genotyping.

The methods and devices of the present invention are particularly useful in the analysis of biological molecules for diagnostic and research applications. Preferred applications of the present invention include, but are not limited to, injection and separation of microquantities of biological materials such as proteins and genetic material (RNA, DNA, etc.) using a novel system of intersecting micro-channels and methods which allow for increased sample throughput relative to existing methods and devices.

### BRIEF DESCRIPTION OF THE DRAWINGS

FIGS. 1A and 1B are diagrammatic top views of the elements of two embodiments of the device provided for by the present invention.

FIGS. 2A and 2B are diagrammatic top and sectional elevation views, respectively, of an embodiment according to the present invention prior to the introduction of separation material or sample into the device. (FIG. 2B is taken along dotted line 2B-2B in FIG. 2A).

FIGS. 3A and 3B are diagrammatic top and sectional elevation views, respectively, of an embodiment according to the present invention after separation material has been introduced into the device, and a sample has been introduced into the sample reservoir. (FIG. 3B is taken along dotted line 3B-3B in FIG. 3A).

FIGS. 4A and 4B are diagrammatic top and sectional elevation views, respectively, of an embodiment according to the present invention illustrating the location of various fluids within the channels after the sample has moved through the injection channel, crossing the intersection of the injection and separation channels. (FIG. 4B is taken along dotted line 4B-4B in FIG. 4A).

FIGS. 5A and 5B are diagrammatic top and sectional elevation views, respectively, of an embodiment according to the present invention illustrating the location of various fluids within the channels after a “plug” of sample has begun to move away from the intersection of the injection and separation channels, (ice: down the separation channel), with a buffer (which is introduced after the sample) passing through the injection channel. (FIG. 5B is taken along dotted line 5B-5B in FIG. 5A).

FIGS. 6A and 6B are diagrammatic top and sectional elevation views, respectively, of an embodiment according to the present invention illustrating the location of various fluids within the channels after a second sample has been introduced into the injection channel. (FIG. 6B is taken along dotted line 6B-6B in FIG. 6A).

FIGS. 7A and 7B are diagrammatic sectional elevation views depicting various approaches for loading multiple samples onto a device of the present invention.

FIGS. 8A-8D are schematic views which illustrate different embodiments according to the present invention wherein multiple sample reservoirs, injection channels and separation channels are connected in arrays.

FIGS. 9A-9C are diagrammatic top views showing different basic arrangements of the injection and separation channel in various embodiments according to the present invention.

FIG. 10 is a diagrammatic top view of the injection and separation channel showing the separation of a plurality of different samples which have been injected onto the separation channel one after another in series.

### DETAILED DESCRIPTION OF THE PREFERRED EMBODIMENTS

Before the present device and methods are described, it should be appreciated that the invention described herein is not limited to the particular component parts of the devices described or process steps of the methods described as such devices and methods may vary. It should be further appreciated that the following are descriptions of preferred embodiments and the invention is not to be considered limited by the particular embodiments described herein. It is also to be understood that the terminology used herein is for purposes of describing particular embodiments only, and is not intended to be limiting, since the scope of the present invention is governed only by the appended claims.

I. General

This invention pertains to new sample injection and separation systems and methods on microfabricated analytical devices formed on a substrate or wafer.

The injection device of the present invention includes a first channel or injection channel which intersects with a second channel or separation channel to form a cross-channel. The device and methods of the present invention allow for the rapid injection and separation of components in a system of micro-channels or capillaries formed into a substrate. In contrast to other microfluidic systems which tend to exclusively use electric forces to move and separate the components in a sample through the capillary-sized channels, the present invention utilizes two forces of different types for injecting and separating the components in a sample in the micro-channel system.

Preferably, the present invention uses either pressure differentials or electrokinetic injection techniques to inject small amounts of sample onto the electrophoretic separation channel of the micro-channel network.

The injection channel preferably includes a sample reservoir at one end and a waste reservoir at another end. The injection channel may also include an injection interface to facilitate sample injection into the sample reservoir and injection channel. A device capable of generating a pressure differential between different sections of the injection channel is used to quickly and efficiently move samples through the injection channel. The sample reservoir can be adapted to allow for the serial addition of multiple samples in rapid sequence. In one embodiment, a capillary tube capable of holding multiple sample fluid plugs is positioned so as to be in fluid communication with the sample reservoir to allow multiple samples to be loaded into the sample reservoir in series.

The second channel comprises an electrophoretic separation channel which intersects the first channel. The separation channel, like the injection channel, preferably includes a reservoir positioned at each end. Each reservoir is in electrical communication with an electrode. The electrodes are used to generate a controlled electric field between the two reservoirs associated with the separation channel. Thus, separation of components in the injected sample is under the influence of an applied electric field and hence involves an electrophoretic separation. A separation material is preferably included within the separation channel to enhance separation of the components in the injected sample. This separation material may be of a variety of types and may include, for example, any of the standard chromatographic materials. Different sieving or gel materials may also be utilized. By judicious selection of the appropriate separation material, a separation can be achieved on the basis of any of a number of different parameters, such as charge, size, chemical characteristics, or combinations thereof. The separation channel may also include a detector for monitoring the presence of various components with the injected sample.

The analytical device and methods of the present invention confer many significant advantages as compared to similar devices and methods. A primary advantage is the significant increase in sample throughput possible with the present device and methods. Increased throughput is possible because the device of the present invention is optimized for repeated serial injections or pulsed injection of samples without having to change any separation material or matrix that may be included with the separation channel, as will be explained. Thus, it is not necessary to interrupt the separation process. It is also possible to use samples of varying volumes. Advantageously, the methods allow for scaling the volume of the injected sample to volumes of less than a microliter. As noted above, the injection methods of the present invention can be used to analyze samples of varying types and to achieve separation on the basis of a number of different criteria. However, the device and methods of the present invention are particularly useful for DNA analysis using electrophoretic methods to separate DNA fragments with the injected DNA sample, such as during genotyping.

II. Design of Analytical Device

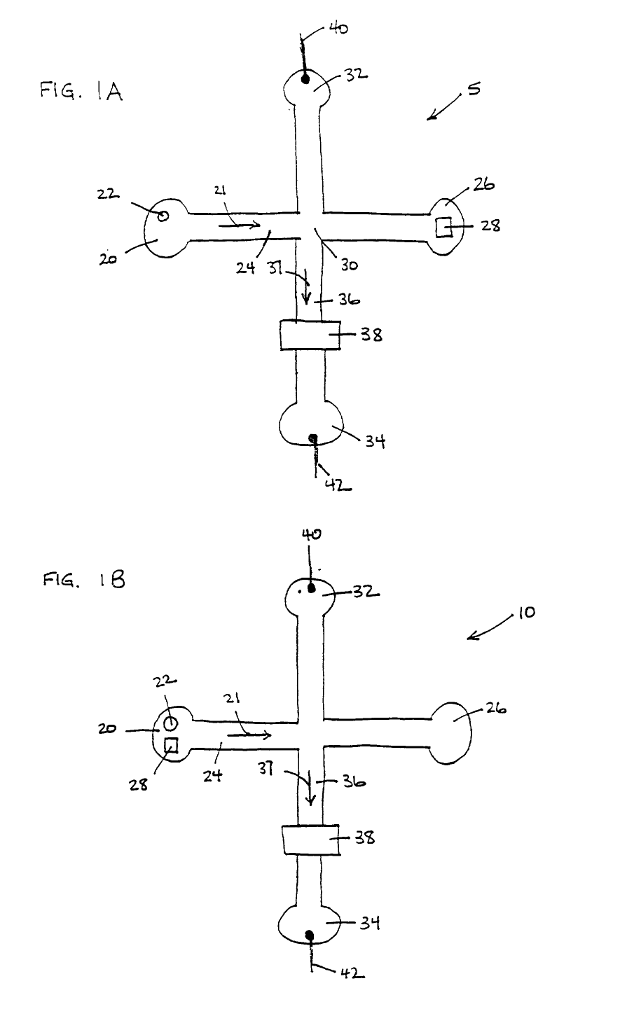

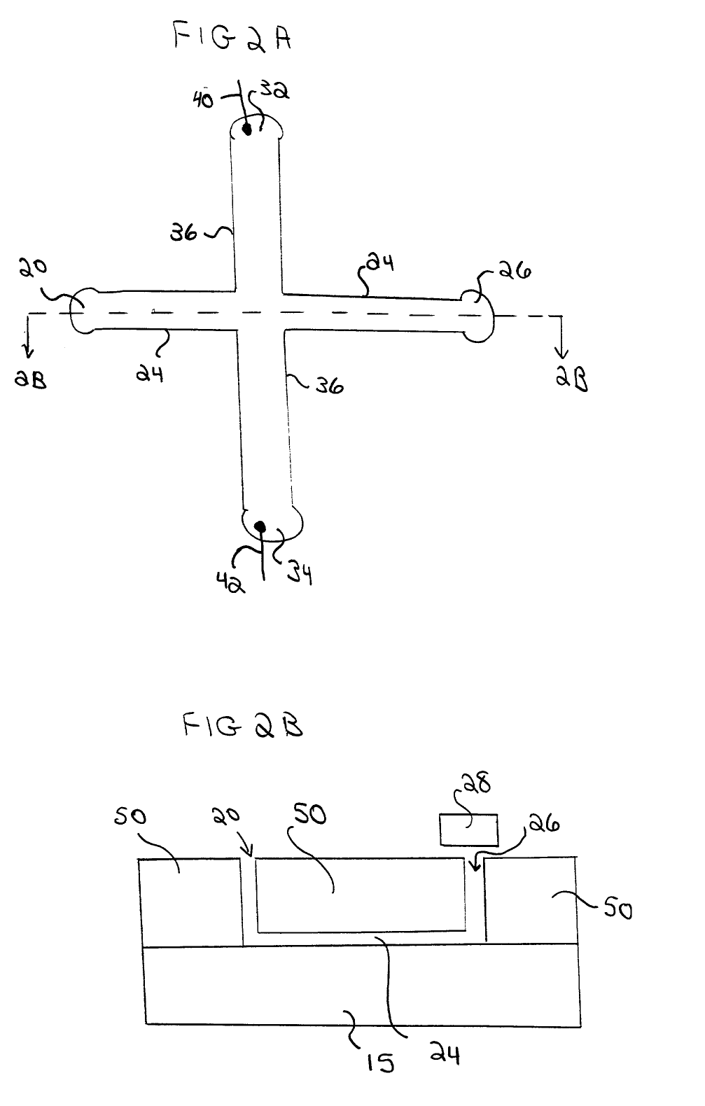

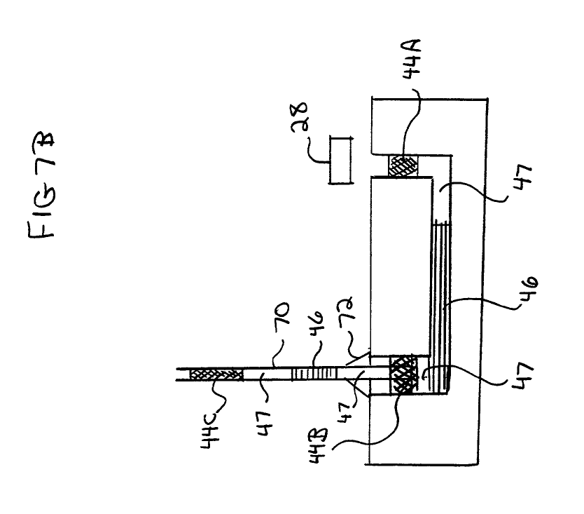

The general design of one embodiment of the analytical device 5 of the current invention can be seen with reference to FIG. 1A. The device 5 includes two intersecting channels, a first or injection channel 24 and a second or separation channel 36, which are formed into the surface of a substrate or wafer. The two channels 24, 36 intersect at point 30. The injection channel 24 preferably includes a sample reservoir 20 at one end and a waste reservoir 26 at an opposite end. Optionally, device 5 may include an injection interface 22 joined so as to be in fluid communication with sample reservoir 20. Injection interface 22 may be used to facilitate the injection of sample or samples into the sample reservoir 20, as will be explained. For example, where the sample is injected by syringe, the device 5 may include a syringe interface which acts to guide the syringe needle into the sample reservoir 20 and a seal. As described more fully below, sample reservoir 20 may also be connected to a capillary tube which permits several samples to be loaded therein in sequence (see FIGS. 7A & 7B and the discussion relating thereto).

Sample flow through the first channel or injection channel 24 (in the direction shown by arrow 21) is controlled by generating a first force to move the sample through the injection channel 24. In a preferred embodiment, a pressure differential generator 28 is positioned at the waste reservoir 26 and creates a pressure differential between the sample reservoir 20 and the waste reservoir 26 which causes the injected sample to flow therebetween. In an especially preferred embodiment, the pressure differential generator 28 is a vacuum generator which creates a low pressure at waste reservoir 26, thereby causing sample flow from the sample reservoir 20 to the waste reservoir 26. A cover slide or plate (not shown) preferably covers the channels 24, 36 to allow the pressure differential to be formed in the injection channel 24.

In an alternate embodiment, the first force, (which is used to inject the samples(s) onto the second channel or separation channel 36), is an electrokinetic force which is created between electrodes (not shown) positioned in each of sample reservoir 20 and waste reservoir 26.

The second channel or separation channel 36 also includes two reservoirs 32 and 34 located at opposing ends of the separation channel 36. A detector 38 may be positioned at a point in the separation channel 36 for use in detecting the presence and/or quantity of the various components which may be contained in the injected sample. Application of a second force (differing in type from the first force used to move sample through the injection channel 24) to the separation channel 36 causes at least a portion of the sample in the injection channel 24 to move into the separation channel 36 and through the separation channel 36 as indicated by arrow 37 (of course, depending upon the direction of the electric field and the nature of the components in the sample, the sample components could flow through the separation column in the reverse direction).

The second force is preferably an electrophoretic or electrosmotic force generated by an electric field. The electric field can be formed, as illustrated in FIG. 1A, by a pair of electrodes 40, 42, in electrical communication with the solution in the two reservoirs 32, 34 associated with the separation column 36. The electrodes 40 and 42 are connected to a suitable power supply (not shown) which allows for the creation of an electric field of the desired strength. As described in greater detail below, the separation channel 36 may include any of a number of different separation materials (not shown) to increase the efficacy at which components within the sample are resolved.

The injection channel 24 and the separation channel 36 intersect so as to be in continuous fluid communication with one another. This design contrasts with other devices wherein gates or valves are positioned at the intersection of the channels to alternately open and close the channels. The design of the present invention which maintains continuous fluid communication between the two channels 24, 36, allows for more rapid sample injection and sample analysis as compared to other devices using gates or valves wherein sample injection and separation occur as distinct and independent steps. The design of the present invention is also considerably easier and less expensive to manufacture. As noted above, injection channel 24 and separation channel 36 are also connected and appropriately sized so that at least a portion of the sample flowing through the injection channel 24 moves from the injection channel 24 into the separation channel 36.

FIG. 1B illustrates a device 10 according to another embodiment of the present invention which is similar to that depicted in FIG. 1A, the difference being that the pressure differential generator 28 is positioned at the sample reservoir 20 instead of at the waste reservoir 26 of the injection channel 24. In this particular embodiment, pressure differential generator 28 generates a positive pressure at the sample reservoir 20 in order to force sample towards the waste reservoir 26 as indicated by solution flow arrow 21.

Alternate systems for generating a pressure differential (and sample flow) in first channel 24 can include the application of different pressures at each of the reservoirs 20 and 26.

III. Analytical Separation Methods

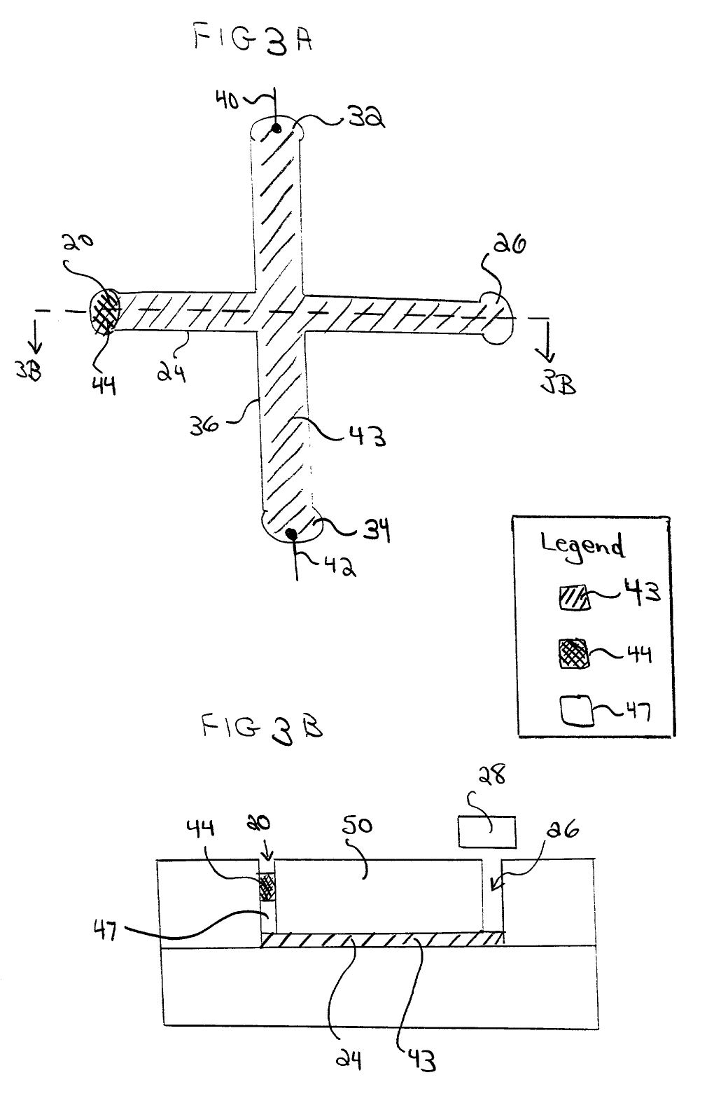

With the foregoing description of the device of the present invention it is possible to now more filly set forth the preferred methods of the present invention. The methods can best be understood with reference to FIGS. 2A to 6B, inclusive, which illustrate solution flow through the channels at different stages of the process. The methods of the present invention provide for a way of rapidly injecting, separating and analyzing the components of samples of various types and volumes.

At the outset, as depicted in FIG. 2A (a top view of the cross channel) and FIG. 2B (a sectional elevation view of the cross channel taken along dotted line 2B-2B in FIG. 2A), the injection channel 24 and the separation channel 36 which are formed into substrate 15 are preferably free of sample 44 and any separation material 43. A cover plate 50 preferably covers the channels 24 and 36 and intersection 30 so that at the appropriate time pressure differential generator 28 positioned over waste reservoir 26 can be utilized to generate a pressure differential in the injection channel 24 to move sample from sample reservoir 20 to waste reservoir 26. Electrodes 40 and 42 are positioned at different positions within the separation channel 36 (preferably at reservoirs 32 and 34 (see FIG. 1A) located at either end of the separation channel 36) for subsequent generation of an electric field within the separation channel 36.

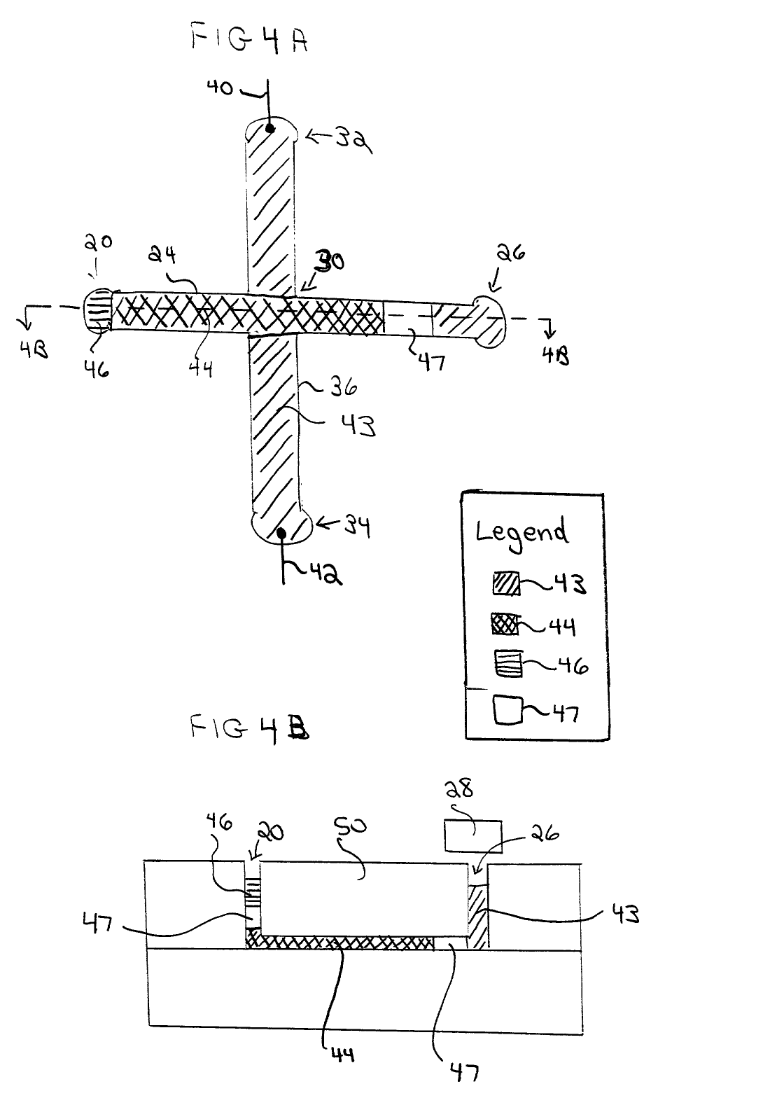

As illustrated in FIGS. 3A and 3B, separation material 43 is introduced into injection channel 24 and separation channel 36. (The separation media can be conveniently introduced through any one of reservoirs 20, 26, 32 and 34). A sample 44 is then loaded into the sample reservoir 20. As will be described in reference to FIGS. 7A and 7B, multiple samples may be loaded in series into the sample reservoir 20, with the samples preferably being separated by a layer of buffer 46 and/or an optional air bubble 47 therebetween. As also described earlier, an injection interface such as a needle guide (not shown in FIGS. 3A and 3B) can be positioned at the sample reservoir 20 to aid in sample injection therein.

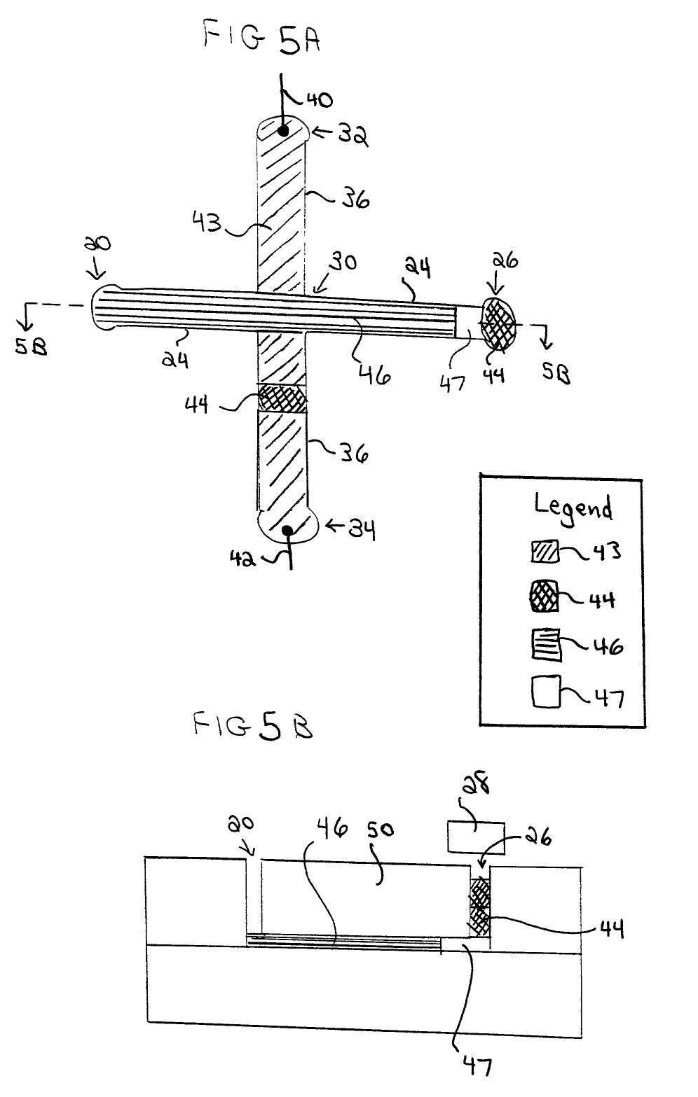

With reference now to FIGS. 4A and 4B, a pressure differential is then generated within the injection channel 24 using pressure differential generator 28. Preferably pressure differential generator 28 is a vacuum generator so that a reduced pressure is generated at waste reservoir 26 (as indicated by arrow 52), although, as noted above, a pressure could also be applied at sample reservoir 20. Regardless of how created, the pressure differential causes separation material 43 to flow out of the injection channel 24 and into the waste reservoir 26, while simultaneously causing sample 44 to move from the sample reservoir 20 into the injection channel 24. In the case in which a vacuum is applied to create the pressure differential, some separation material 43 may be pulled from the separation column 36. However, because the separation material 43 often has a relatively high viscosity and because the separation channel 36 is relatively long, the amount of separation material 43 removed from the separation channel 36 is generally inconsequential to the functioning of the device.

An electric field or voltage is also applied across the separation channel 36 at this stage using electrodes 40, 42 and the power supply (not shown) connected thereto. As sample 44 moves through the injection channel 24 and into the intersection 30 of the two channels 24, 36, at least a portion of the injected sample 44 is drawn into the separation channel 36.

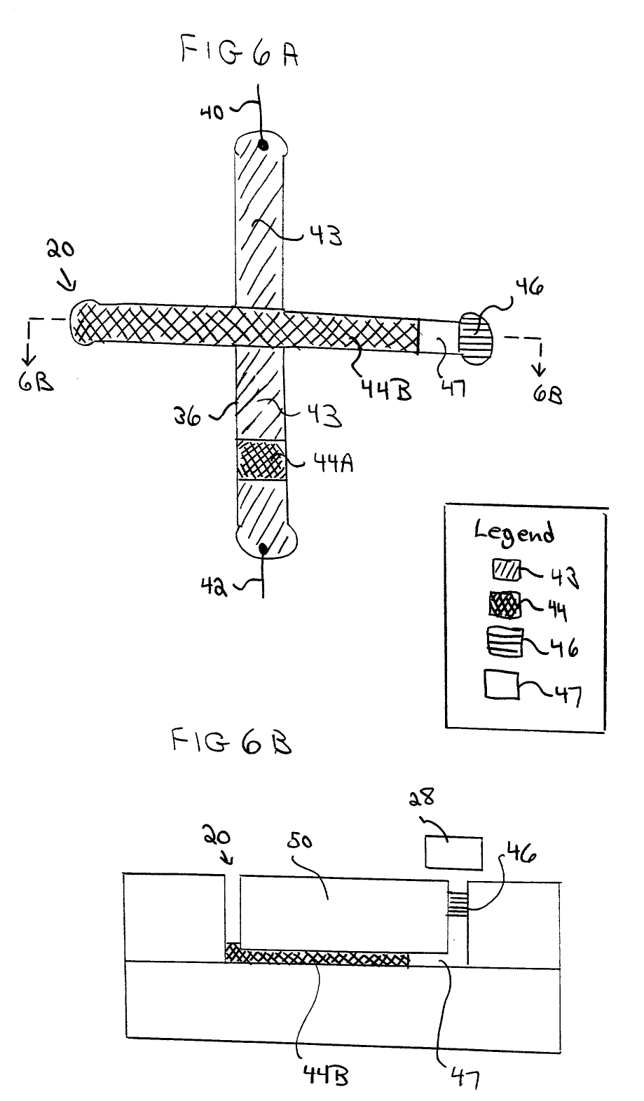

Once a sample 44 has passed completely from sample reservoir 20 through intersection 30 and into waste reservoir 26, a buffer 46 may be introduced into sample reservoir 20. As depicted in FIGS. 5A and SB, the application of the same force which moved sample 44 from sample reservoir 20 to waste reservoir 26 causes buffer 46 to pass through intersection 30 of the two channels 24, 36.

As can also be seen, a “plug” of sample 44 remains disposed in separation channel 36 as buffer 46 passes from sample reservoir 20 through intersection 30 and into waste reservoir 26. Preferably, buffer 46 then removes any residual sample 44 remaining in the injection channel 24. Advantageously, the presence of buffer 46 in injection channel 24 may also complete the electrical connection between the electrodes 40, 42 thus permitting sample 44 to be electrophoretically separated by separation material 43 in channel 36 as buffer 46 passes from sample reservoir 20 through intersection 30.

It is to be understood that air bubbles 47 are optional. In the aspect of the invention in which samples are loaded onto separation channel 36 by a pressure differential across channel 24, bubbles 47 may be used to separate samples. However, in the aspect of the invention in which samples are loaded onto separation channel 36 by an electokinetic force across channel 24 bubbles 47 are omitted such that an electrical contact can be maintained across the fluid column comprising sequential fluid samples with fluid buffers separating them.

In the aspects of the invention in which small air bubbles 47 are used to separate multiple samples, once an air bubble enters the intersection 30 of the two channels 24, 36, it momentarily interrupts the electrical connection between electrodes 40, 42, thereby causing the separation in the separation channel 36 to cease. However, when the next liquid (either sample or buffer) flows through intersection 30, the connection between electrodes 40, 42 is restored and the separation of components in the separation channel resumes.

IV. Multiple Serial Sample Injection

Samples can be injected one after another into the sample reservoir in a variety of different ways. For example, as described above, sample reservoir 20 may include an injection interface which provides guides for directing the insertion of a syringe needle into the reservoir and the necessary seals to prevent sample leakage. As such, a variety of different samples may be introduced one after another into the sample reservoir simply by injecting the samples one after another into sample reservoir 20.

In preferred aspects, when samples are introduced into sample reservoir one after another, the respective samples may be separated from one another either by “plugs” of buffer therebetween or by air bubbles therebetween or by both plugs of buffer and air bubbles therebetween. It is to be understood that the present invention encompasses both introducing separate “plugs” of the sample, (separated by “plugs” of buffer or air bubbles), and introducing separate “plugs” of different samples, (separated by “plugs” of buffer or air bubbles). As such, various techniques are contemplated within the scope of the present invention.

For example, plugs of sample can be separated by air bubbles therebetween. This advantageously prevents mixing of the samples, (and also avoids the problem of sample plugs mixing with buffer plugs spaced therebetween). This approach is particularly well suited to the aspect of the present invention in which pressure differentials are used to load the electrophoretic separation channel.

Secondly, plugs of sample can be separated by plugs of buffer tberebetween (with no air bubbles). This approach is particularly well suited to the aspect of the present invention in which an electrokinetic force is used to load the electrophoretic separation channel.

Thirdly, plugs of sample can be separated by both plugs of buffer and air bubbles therebetween. An example would be as follows:

“Sample 1—air bubble—buffer—air bubble—Sample 2—air bubble buffer—air bubble—Sample 3”

This approach is particularly well suited to both prevent samples mixing either with one another, or with buffers. In any of the above cases, an advantage of separating sequential “plugs” of samples” with either “plugs” of buffer or with air bubbles therebetween is that it effectively eliminates any diffusion or mixing of samples.

An optional capillary system for serially introducing multiple plugs of sample into the present sample reservoir is illustrated in FIG. 7A. In this preferred approach, one end of a capillary 62 is placed in the sample reservoir 20 and the other end is alternately placed in a container 60 containing sample 44 or buffer 46. In one embodiment, a pressure is applied to reservoir 60, assisting in loading of the sample into capillary 62, and pushing it into sample reservoir 20. Alternatively, a pressure differential may be created by pressure differential generator 28 positioned at waste reservoir 26, in this case a vacuum, is used to pull sample 44 or buffer 46 from the container 60 through the capillary tube 62 and into the sample reservoir 20. In either case, the pressure differential created at waste reservoir 26 (as indicated by arrow 52) causes sample 44 to continue flowing from sample reservoir 20 into injection channel 24 towards waste reservoir 26. It is to be understood that either: (a) multiple samples can be loaded into the sample reservoir (or capillary tube) prior to generating a pressure differential, or (b) multiple samples can be loaded into the sample reservoir (or capillary tube) in real time concurrently with a pressure differential being maintained.

Yet another approach is illustrated in FIG. 7B. In this case, capillary 70 is directly connected to sample reservoir 20 by a binding agent 72, such as epoxy for instance. As illustrated in FIG. 7B, the design allows for the facile addition and stacking of multiple samples within the capillary 70. Movement of the samples downward through capillary 70 into sample reservoir 20 and into injection channel 24 is under the pressure differential created by pressure differential generator 28. Other methods of sample injection include robotic pipetting, piezoelectric/thermal dispensers and interfaces to other microfluidic networks.

In preferred aspects, the ionic concentration of the sample is significantly lower than the buffer or the separation material. The lower concentration of the sample creates an increase in the local applied field and increases the injection efficiency, i.e., the amount of sample which moves from the injection channel onto the separation channel, thereby resulting in an increased signal with no decrease in resolution.

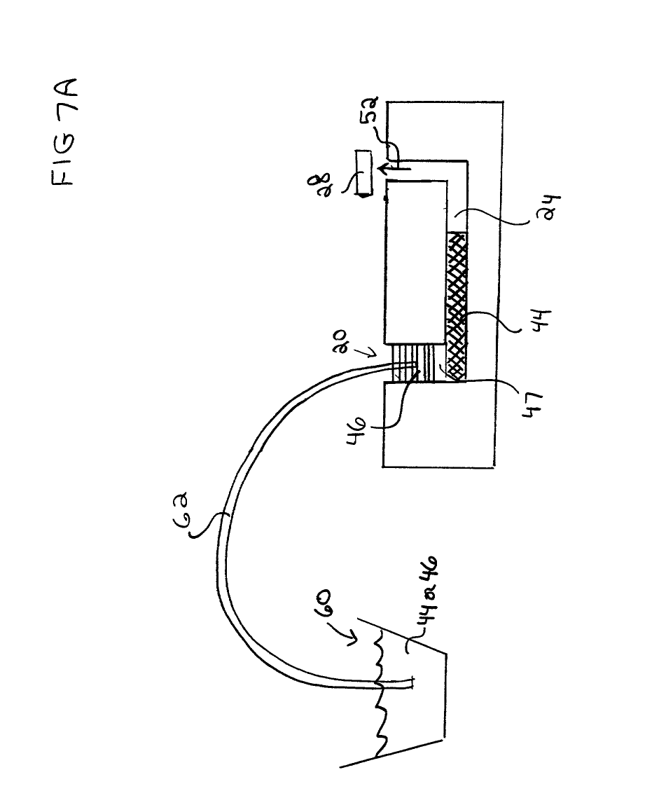

Multiple serial sample injection is shown in FIGS. 6A and 6B. Specifically, multiple “plugs” of samples 44A and 44B are loaded into sample reservoir 20. The second sample (44B), which is separated from the first sample (44A) by buffer 46 and optional air bubble 47, is introduced into injection channel 24 and onto separation channel 36 by the pressure differential in the injection channel 24, just as in the case of the first sample (44A), as was described above in relation to FIGS. 2A-5B.

Although FIGS. 5A-6B depicts a situation wherein the second sample 44B is not introduced into the injection channel 24 until the first sample 44A had fully passed into the waste reservoir 26, the second sample 44B could in fact have begun flowing through the injection channel 24 before first sample 44A had fully passed through injection channel 24. Specifically, the buffer 46 and air bubble 47 separating samples 44A and 44B provides sufficient separation between the samples to avoid any problems of intermixing of the samples. In fact, a subsequent sample can be introduced into the separation column 24 before the preceding sample has cleared intersection 30.

Similarly, as depicted in FIG. 10, multiple samples (44A, 44B, 44C and 44D) can be running through the separation channel 36 simultaneously. This is true even though samples 44A, 44B, 44C and 44D have been introduced through channel 24 sequentially. Thus, it is possible for a portion of a subsequent sample to enter the separation channel 36 before all the components of the preceding sample have fully eluted from the separation channel 36. Preferably, however, the samples are sequentially introduced such that there is sufficient separation between the samples so that the slowest traveling component of the preceding sample is not overtaken by the fastest moving component of the subsequent sample.

As illustrated in the foregoing figures, it is also not necessary to refill the separation channel 36 with new separation material 42 between sample 44 injections. Instead, the components of multiple samples can be separated before it is necessary to change the separation material 43 in the separation channel 36. In fact, as just described, it is possible to have multiple samples being separated on the separation channel 36 simultaneously.

V. Separation and Detection in Separation Channel

A variety of different separation materials can be utilized to effectuate separation of components within the injected samples. In general any chromatographic material could be utilized, including, for example, absorptive phase materials, ion exchange materials, affinity chromatography materials, materials separating on the basis of size, as well as those separating on the basis of some functional group. A variety of electrophoretic materials can also be used. Of particular utility are cellulose derivatives, polyacrylamides, polyvinyl alcohols, polyethylene oxides, and the like. Preferred electrophoretic media include linear acrylamide and hydroxyethyl cellulose, polyvinyl alcohol and polyethelene oxide.

Various optional detectors (38 in FIGS. 1A and 1B, and omitted elsewhere for ease of illustration) may be used depending upon the nature of the components being separated. For example, detector 38 may be any of a variety of optical or electrochemical detectors. For optical detectors, it is advantageous for cover plate 50 to be manufactured of a material which is optically transparent in the spectral range measured by the detector.

VI. Controlled Movement of Samples Through Injection and Separation Channels

As described above, after a sample is injected into injection channel 24, it is preferably moved through the injection channel by applying a pressure differential across the injection channel. In one embodiment, the pressure differential is generated by applying a vacuum to the waste reservoir to create a low pressure at the waste reservoir which causes the sample to move from sample reservoir 20 towards waste reservoir 26. In an alternate embodiment, pumps or related devices could be used to create a pressure in injection channel 24, such as at sample reservoir 20, thereby forcing the sample through injection channel 24. In some cases it may be possible to move the sample through injection channel 24 by gravity flow. Other methods for creating the pressure differential include electrosmotic flow, acoustic waves and pumps.

The portion of the injected sample which moves from injection channel 24 into separation channel 36 is subjected to an electrical field which causes the components of the sample to move and separate on separation channel 36. The electric field applied to separation channel 36 can be applied and varied in a controlled manner by using a voltage controller. Of particular value, especially when arrays of cross-channels are used and there are multiple reservoirs, the voltage controller can simultaneously apply a selectable voltage level, including ground, to each reservoir. The voltage controller may utilize multiple voltage dividers and relays to obtain the selectable voltage levels. Alternatively, multiple independent voltage sources may be used. The voltage controller is electrically connected to each of the reservoirs by an electrode which is positioned or fabricated within each of the reservoirs. A description of how this is accomplished is set forth in PCT publication WO 96/04547 to Ramsey, and is incorporated herein by reference in its entirety for all purposes.

In contrast to related devices, the present device and methods do not require gates or valves at the intersection of the channels to regulate flow. Instead, the injection channel and separation channel are in continuous fluid communication with one another. Sample movement is controlled simply through the application of a pressure differential and an electric field. Preferably, these two forces are applied simultaneously to enhance sample throughput.

Sample throughput is also improved by using a pressure differential to flow sample through the injection channel. For example, the use of a vacuum has the advantage of aiding in removing residual sample in multisample injections, thereby reducing the amount of remaining sample needed to be flushed out of the injection channel with buffer in between samples.

VII. Samples

A. Type and Source

The analytical devices and methods provided by the current invention can be used in a wide variety of separation based analyses, including sequencing, purification, and analyte identification applications for clinical, environmental, quality control and research purposes. Consequently, the type of samples that can be analyzed using the devices and according to the methods of the present invention is equally as diverse. Representative samples types include bodily fluids, environmental fluid samples, or other fluid samples in which the identification and/or isolation of a particular compound(s) is (are) desired.

The source of the sample may be blood, urine, plasma, cerebrospinal fluid, tears, nasal or ear discharge, tissue lysate, saliva, biopsies, and the like. Examples of the types of compounds actually analyzed include, for instance, small organic molecules, metabolites of drugs or xenobiotics, peptides, proteins, glycoproteins, oligosaccharides, oligonucleotides, DNA, RNA, lipids, steroids, cholesterols, and the like.

B. Sample Volume

The amount of sample initially injected into the sample reservoir can be varied, and can be less than 1 microliter in volume. The length of the injection plug and the amount of sample actually moving from the injection channel onto the separation channel is controlled by the applied voltage as the sample passes through the injection channel, the amount of sample placed in the sample reservoir, and the flow rate of the sample as it passes through the cross channel injector, i.e. the intersection of the injection channel and the separation channel.

VIII. Substrate/Wafer Composition

The substrate upon which the micro-channel network of the analytical devices of the present invention are formed can be fabricated from a wide variety of materials, including glass, fused silica, and various plastics, and the like. Other components of the device, especially the cover plate, can be fabricated from the same or different materials, depending on the particular use of the device, economic concerns, solvent compatibility, optical clarity, mechanical strength and other structural concerns. However, in other cases, the cover plate may be manufactured from materials different from those used to make the substrate. Glass is a preferred material for manufacturing the devices, as well as related materials such as fused silica.

Preferably, the substrate is manufactured of a non-conductive material to allow relatively high electric fields to be applied to electrokinetically transport the samples through the separation channel. Semiconducting materials such as silicon could be used, but in such cases the applied electric field would typically have to be kept low and an insulating layer should be applied to the substrate.

In the case of polymeric substrates such as plastics, the substrate materials may be rigid, semi-rigid, or non-rigid, opaque, semi-opaque or transparent, depending upon the use for which the material is intended. Plastics which have low surface charge when subjected to the electric fields of the present invention and thus which are of particular utility include, for example, polymethylmethacrylate, polycarbonate, polyethylene terepthalate, polystyrene or styrene copolymers, polydimethylsiloxanes, polyurethane, polyvinylchloride, polysulfone, and the like.

Devices which include an optical or visual detector are generally fabricated, at least in part, from transparent materials to facilitate detection of components within the separation channel by the detector.

IX. Channel Structure and Formation

A. Channel Structure

The size and shape of the micro-channels formed in the substrate of the present devices is generally not critical. The channels can have essentially any shape, including, but not limited to, semi-circular, cylindrical, rectangular and trapezoidal.

The depth of the channels can vary, but tends to be approximately 10 to 100 microns, and most typically is about 50 microns. By virtue of the preferred manufacturing process (isotropic chemical etching—see below), the channels tend to be approximately twice as wide as they are deep. Thus, the channels tend to be 20 to 200 microns wide, and most typically are about 300, or more preferably 200, or most preferably about 100 microns wide. The actual width, however, is not critical.

With reference once again to FIG. 4A, the length of the injection channel 24 from the sample reservoir 20 and intersection 30 is preferably approximately 1 cm or less, and more preferably is about 1 to 10 mm. A relatively short distance between the sample reservoir 20 and the intersection 30 of the two channels is preferred in order to minimize the amount of separation material 43 which is pulled out of the separation channel 36 as another fluid, (such as a “plug” of buffer or sample 44) is pulled into the injection channel 24 by the low pressure created at the waste reservoir 26 by the pressure differential generator 28 (e.g., a vacuum generator). By keeping the distance between the sample reservoir 20 and intersection 30 short, the pressure differential only needs to be applied for a very short time. In fact, since there is only minimal opportunity for the sample 44 to be pulled from the separation channel 36, the applied pressure differential may even be continuous. The distance between intersection 30 and waste reservoir 26, in contrast, can vary significantly, such as from 1 to 20 cm; more preferably this distance is approximately 1 to 10 mm.

The entire length of separation channel 36 (the distance between the points at which the reservoirs 32, 34 connect to the ends of the separation channel) is not critical, but typically ranges from 2 to 10 cm in length, although the channel could be even longer (such as 30 centimeters, for example). The length of the separation channel 36 will vary depending upon the number of components contained in the injected sample, the degree of resolution required, the magnitude of the applied field, the type of separation material, and the like.

B. Channel Formation

Manufacturing of the channels and other elements formed in the surface of the substrate can be carried out by any number of microfabricating techniques that are well known in the art. For example, lithographic techniques may be employed in fabricating glass or quartz substrates, for example, using methods which are well known in the semiconductor manufacturing industries. Photolithographic masking, plasma or wet etching and other semiconductor processing technologies can be utilized to create microscale elements in and on substrate surfaces. Alternatively, micromachining methods, such as laser drilling, micromilling and the like, may be utilized. For polymeric substrates, a variety of well known manufacturing techniques may also be used. These techniques include injection molding techniques, stamp molding methods, using for example, rolling stamps to produce large sheets of microscale substrates, or polymer microcasting techniques, wherein the substrate is polymerized within a micromachined mold.

After forming the channels, the cover plate may be attached to the substrate by a variety of means, including, for example, thermal bonding, adhesives or, in the case of certain substrates (e.g., glass, or semi-rigid and non-rigid polymeric substrates), a natural adhesion between the substrate and cover plate. The cover plate may additionally be provided with access ports and/or reservoirs for introducing the various liquids into the channels.

X. Alternate Channel Arrangements

A. General Types of Intersecting Arrangements

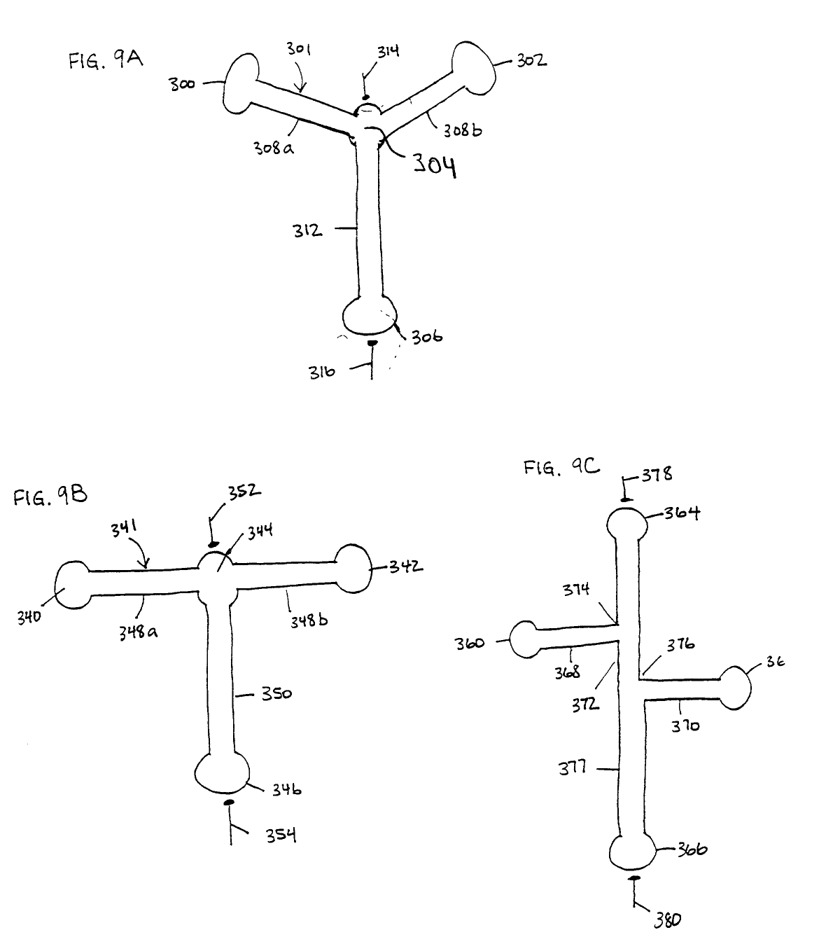

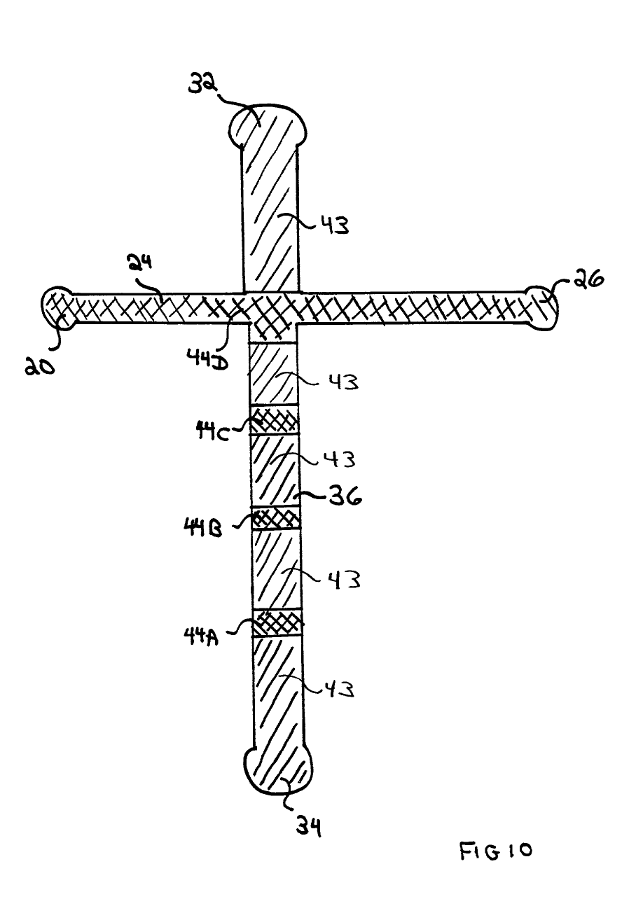

The arrangement of the channels as illustrated in FIGS. 1A to FIG. 6B involves an arrangement wherein the injector and separation channels 24, 36 intersect and cross each other at a 90 degree angle. This particular arrangement is not required, however. A variety of other configurations of the two channels can be utilized. For example, FIG. 9A depicts a configuration in which the injection channel 301 (composed of two sections 308a and 308b) and separation channel 312 intersect to form a substantially “Y” shape. One end of one of the injection channel 0sections 308a is in fluid communication with sample reservoir 300; similarly, one end of the other injection channel section 308b is connected to waste reservoir 302. The other ends of these two sections 308a, 308b intersect one another, and one end of the separation channel 312, at reservoir 304. The opposite end of the separation channel 312 is connected to reservoir 306. Reservoirs 304, 306 are electrically connected to electrodes 314, 316, respectively.

In a second alternate arrangement, the two channels intersect to form substantially a “T” shape, as illustrated in FIG. 9B. In this instance also, the injection channel 341 includes two sections, 348a and 348b. One end of these sections 348a and 348b are connected to the sample reservoir 340 and the waste reservoir 342, respectively. The sections 348a and 348b are connected at their other ends to common reservoir 344, as is one end of separation channel 350. The other end of separation channel 350 is connected to reservoir 346. Electrodes 352, 354 are in electrical communication with reservoirs 344, 346, respectively.

Yet another embodiment, referred to as a twin T configuration, is shown in FIG. 9C. In this embodiment, the injection channel includes two sections 368 and 370 which are offset. One end of section 368 is connected to sample reservoir 360 and the other end intersects with separation channel 377 at junction 374. The second section 370 of the injection channel is separated from the first section 368 by a section 372 of separation channel 377. Thus, section 370 of the injection channel is connected at one end to separation channel 377 at juncture 376 and is in fluid communication with waste reservoir 362. The section 372 of the separation channel 377 by which the two sections 368, 370 are offset constitute one arm of the “T” like structure which the two sections 368, 370 form with the separation channel 377. The separation channel itself is in fluid communication with reservoirs 364, 366 at its two ends. These two reservoirs 364, 366 are in turn in electrical communication with 378, 380, respectively.

Of course, the channels referred to in the foregoing figures as the injection channel could in fact be the separation channel and vice versa. A number of geometries could also be utilized without departing from the spirit of the present invention as would be appreciated by those skilled in the art.

B. Arrangement of Channels in Arrays

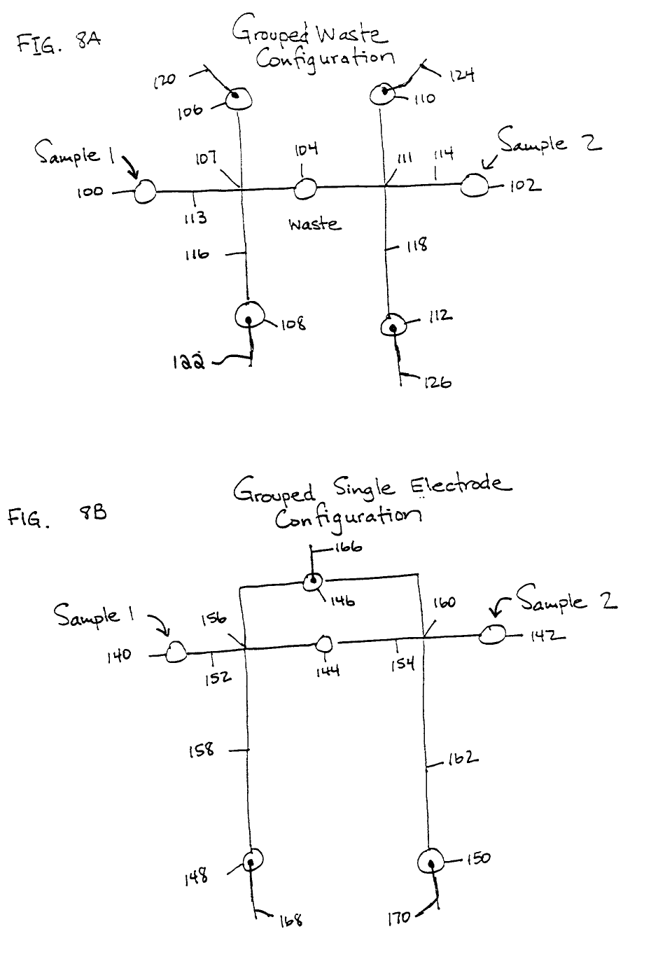

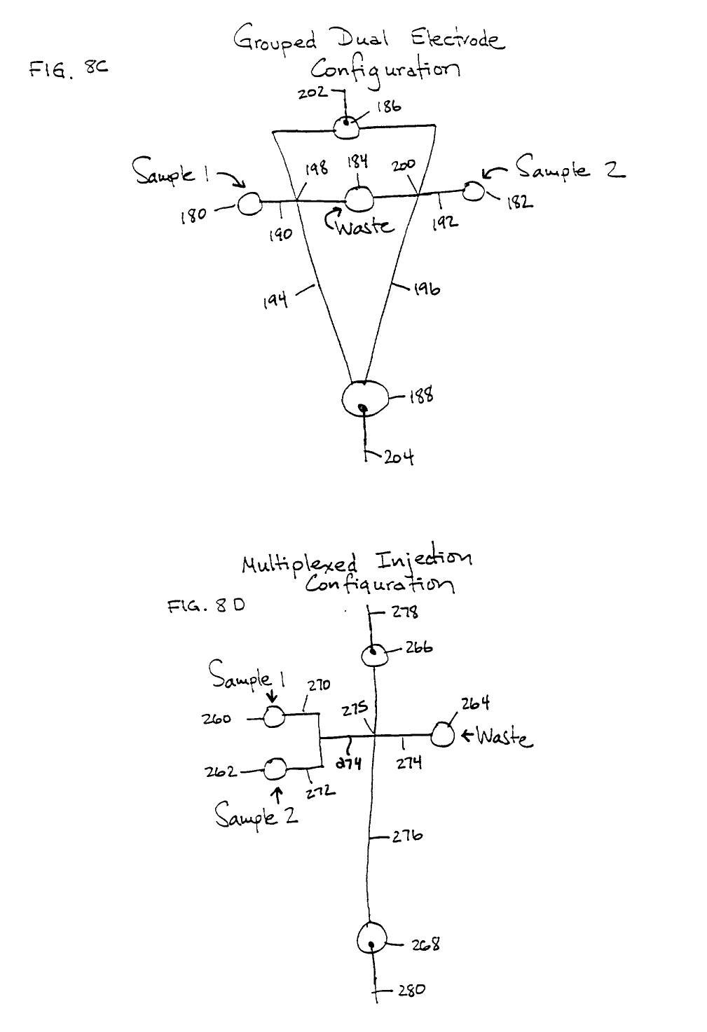

To this point, the devices of the present invention have been described as devices wherein there is a single injection and separation channel. The present invention contemplates, however, designs wherein the separation and injection channels are arranged in arrays, i.e., designs wherein a plurality of injection and/or separation channels, as well as sample reservoirs are included on a single substrate. Various embodiments which illustrate this concept are shown in FIGS. 8A to 8E.

Using arrays, sample throughput can be increased beyond that possible using a single set of injection and separation channels and a single sample reservoir. While multiple samples can be injected into a single sample reservoir as described above, using arrays of cross-channels, it also is possible to simultaneously inject multiple samples into multiple sample reservoirs and to run multiple samples through multiple sets of channels. With certain array structures, it is possible to terminate multiple channels at common points, thereby reducing the number of electrodes and reservoirs needed and simplifying the overall design.

Using the multiple injection techniques set forth above in combination with placing separation columns in arrays such as those described in this section, it is possible to conduct the pressure differential loading (e.g., vacuum loading) in parallel and achieve a significant increase in the sample throughput using the devices of the present invention.

1. Grouped Waste Configuration

For example, FIG. 8A depicts a grouped waste configuration wherein each set of injection and separation channels form a “+” shape, but wherein the two injection channels 113, 114 share a common waste reservoir 104. The other ends of the two injection channels 113, 114 are in fluid communication with sample reservoirs 100, 102, respectively. One separation channel 116 intersects injection channel 113 at intersection point 107; this separation channel 116 is in fluid communication with reservoirs 106, 108, which in turn, are in electrical communication with electrodes 120, 122, respectively.

Likewise, injection channel 114 is intersected by separation channel 118 at junction 111. Separation channel 118 is connected to reservoirs 110, 112, which are also in electrical communication with electrodes 124, 126, respectively.

2. Grouped Single Electrode Configuration

A second array embodiment is shown in FIG. 8B, wherein two separation columns share a common cathode or anode reservoir and electrode. As described for the embodiment depicted in FIG. 8B, injection channels 152, 154 share a common waste reservoir 144. The first injection channel 152 is connected to reservoir 140 at its other end; similarly, the second injection channel 154 is connected to reservoir 142 at its other end. The first separation column 158 intersects the first injection column 152 at intersection point 156 and is in fluid communication with reservoir 146. Second separation column 162 intersects injection column 154 at intersection 160 and is also in fluid communication with reservoir 146. The other ends of the first and second separation columns 158, 162 are in fluid communication with reservoirs 148 and 150, respectively. Electrodes 166, 168, 170 are in electrical communication with reservoirs 146, 148, 150, respectively.

3. Grouped Dual Electrode Configuration

FIG. 8C illustrates another embodiment wherein two separation columns utilize the same electrodes. Like the two array configurations just described, the two sample injection channels 190, 192 of this embodiment are each linked at one end by a common waste reservoir 184. The other end of each injection channel 190, 192 is in fluid communication with a sample reservoir 180, 182, respectively. The two sample injection channels 194, 196 are each joined at one end by reservoir 186 and at the other end at reservoir 188. Separation channel 194 forms an intersection 198 with injection channel 190; similarly, separation channel 196 intersects injection channel 192 at intersection 200. The two reservoirs 186, 188 associated with the separation channels 194, 196 are in electrical communication with electrodes 202, 204, respectively. A design of this type provides for multiple sample injection at two locations and requires only two electrodes.

4. Multiplexed Injection Configuration

This arrangement is shown in FIG. 8D. In this embodiment, the injection channel 274 is connected at one end to two branches 270, 272, each of which is connected to a sample reservoir 260, 262, respectively. The other end of the injection channel 274 is in fluid communication with waste reservoir 264. In this embodiment, there is a single separation channel 276 that intersects the injection channel 274 at junction 275. The separation channel 276 is in fluid communication at one end with reservoir 266 and reservoir 268 at the other end. These two reservoirs 266, 268 are also in electrical communication with electrodes 278, 280.

All publications and patent applications cited above are incorporated by reference in their entirety for all purposes to the same extent as if each individual publication or patent application were specifically and individually indicated to be so incorporated by reference.

What is claimed is:

1. A microfabricated analytical device for at least partially separating the components of a sample, the analytical device comprising:
(a) a first channel having a sample reservoir at one end and a waste reservoir at an opposite end;
(b) a second channel which intersects across the first channel, the second channel comprising an electrophoretic separation channel; and
(c) a pressure system adapted to generate a pressure differential across the first channel so as to move a sample from the sample reservoir across the first channel and into an intersection between the first and second channels.

2. A microfabricated analytical device for at least partially separating the components of a sample, the analytical device comprising:
(a) a first channel having a sample reservoir at one end and a waste reservoir at an opposite end;
(b) a second channel which intersects across the first channel, the second channel comprising an electrophoretic separation channel; and
(c) an electrokinetic system adapted to electrokinetically move a sample from the sample reservoir across the first channel and into an intersection between the first and second channels.

3. The microfabricated analytical device of claims 1 or 2, wherein, the sample reservoir further contains an injection interface.

4. The microfabricated analytical device of claims 1 or 2, further comprising:
a detector positioned along the second channel.

5. A microfabricated analytical device according to claim 1, wherein the sample includes DNA fragments.

6. A microfabricated analytical device according to claim 5, further comprising:
a sieving matrix deposited in the second channel.

7. The microfabricated analytical device of claims 1 or 2, further comprising:
a capillary tube in fluid communication with the sample reservoir, the capillary tube adapted to load a plurality of sample plugs in sequence into the sample reservoir.

8. An analytical device for at least partially separating the components of a sample, the analytical device comprising:
(a) a sample reservoir;
(b) a first channel extending from the sample reservoir;
(c) a second channel which intersects with the first channel, the first and second channels being in fluid communication;
(d) a pressure differential generator adapted to generate a pressure differential across the first channel; and
(e) an electric field generator adapted to create an electrical field in the second channel.

9. The analytical device of claims 1, 2 or 8, wherein the sample reservoir is adapted to receive samples having a volume of approximately 1 microliter or less.

10. The analytical device of claim 8, wherein the sample reservoir is in fluid communication with a capillary tube, the capillary tube being adapted to transfer multiple samples into the sample reservoir.

11. The analytical device of claims 1, 2 or 8, further comprising a sieving matrix in the second channel acting, in conjunction with the electric field, to at least partially separate the components in the sample.

12. The analytical device of claim 11, wherein the sieving matrix is selected from the group consisting of acrylamide, hydroxy cellulose, polyvinyl alcohol and polyethelene oxide.

13. The analytical device of claims 1, 2 or 8, wherein the first and second channel have a diameter of less than 300 microns.

14. The analytical device of claims 1, 2 or 8, wherein the first and second channel have a diameter of less than 200 microns.

15. The analytical device of claims 1, 2 or 8, wherein the first and second channel have a diameter of less than 100 microns.

16. A system for simultaneously analyzing a plurality of samples, comprising:
a plurality of analytical devices as set forth in any of claims 1, 2, or 8, wherein the plurality of analytical devices are fabricated on the surface of a single substrate.

17. The system of claim 16, wherein,
the plurality of analytical devices share a common waste reservoir.

18. The system of claim 16, wherein,
the second channels of the plurality of analytical devices share at least one common electrode.

19. The system of claim 16, wherein,
the second channels of the plurality of analytical devices share two common electrodes.

20. A method for transporting a sample using a device which includes a first channel having a sample reservoir at one end and a waste reservoir at an opposite end and a second channel which intersects across the first channel, comprising:
(a) loading the sample into the sample reservoir;
(b) generating a first force in the first channel to move the sample along the first channel; and
(c) applying a second force in the second channel to move at least a portion of the sample into the second channel, the second force being of a different type than the first force.

21. The method of claim 20, wherein the first force is a pressure differential and the second force is an electric field.

22. The method of claim 20, further comprising:
electrophoretically separating the sample in the second channel.

23. The method of claim 20, further comprising:
loading a plurality of sample plugs in sequence into the sample reservoir with a capillary tube in fluid communication with the sample reservoir.

24. The method of claim 23, wherein the plurality of sample plugs are the same fluid sample.

25. The method of claim 23, wherein the plurality of sample plugs are different fluid samples.

26. The method of claim 23, further comprising:
separating the sample plugs with plugs of buffer positioned therebetween.

27. The method of claim 21, further comprising:
separating the sample plugs with air bubbles positioned therebetween.

28. The method of claim 20, wherein the sample includes DNA fragments and wherein the second channel includes a sieving matrix, the sieving matrix and the electric field acting to at least partially separate the DNA fragments in the sample.

29. A method for analyzing a sample using a device which includes (i) a sample reservoir into which the sample is placed; (ii) a first channel in fluid communication with the sample reservoir and adapted for receiving the sample, (iii) a second channel which intersects with the first channel and which is adapted to receive at least a portion of the sample, the first and second channel being connected so as to provide continuous fluid communication between the first and second channel, (iv) a pressure differential generator, and (v) an electric field generator, the method comprising:
(a) loading the sample into the sample reservoir;
(b) generating a pressure differential in the first channel with the pressure differential generator, the pressure differential acting to move the sample from the sample reservoir into and along the first channel; and
(c) applying an electric field to the second channel using the electric field generator, the electric field acting to move at least a portion of the sample into the second channel.

30. The method of claim 29, wherein loading involves loading multiple samples into the sample reservoir prior to generating a pressure differential.

31. The method of claim 29, wherein loading involves loading multiple samples into the sample reservoir in real time concurrently with maintaining a pressure differential.

32. The method of claim 29, wherein loading involves loading a sample which has a volume of approximately 1 microliter or less.

33. The method of claim 29, further comprising introducing a sieving material into the first and second channel prior to loading the sample into the sample reservoir.

34. The method of claim 33, wherein the sieving material is selected from the group consisting of acrylamide, hydroxy cellulose, polyvinyl alcohol and polyethelene oxide.

35. The method of claim 34, wherein the electric field and the sieving matrix act to at least partially separate the components in the sample by size.

36. An analytical method for the serial injection of multiple samples using a device which includes (i) a sample reservoir designed to receive the samples, (ii) a first channel in fluid communication with the sample reservoir and adapted for receiving the samples, and (ii) a second channel which intersects at an angle with the first channel and is adapted to receive a portion of the samples, the method comprising:
(a) loading multiple samples into the sample reservoir; and
(b) controllably moving the samples along the first channel and diverting a portion of each of the samples into the second channel.

37. The method of claim 36, wherein loading multiple samples comprises:
(a) injecting a first sample into the sample reservoir;
(b) placing a layer of buffer over the first sample;
(c) adding a second sample over the layer of buffer; and
(d) repeating steps (b) and (c) with additional samples.

38. The method of claim 36, wherein loading multiple samples comprises:
(a) injecting a first sample into the sample reservoir;
(b) placing an air bubble over the first sample;
(c) adding a second sample over the air bubble; and
(d) repeating steps (b) and (c) with additional samples.

39. The method of claim 36, wherein loading multiple samples comprises:
(a) injecting a first sample into the sample reservoir;
(b) placing an air bubble over the first sample;
(c) placing a layer of buffer over the air bubble;
(d) placing an air bubble over the layer of buffer;
(e) adding a second sample over the air bubble; and
(f) repeating steps (b) to (e) with additional samples.

40. The method of claim 36, wherein controllably moving the samples along the first channel comprises applying a first force to the first channel and applying a second force to the second channel, the second force being of a different type than the first force.

41. The method of claim 40, wherein the first force is a pressure differential and the second force is an electric field.
